(19) United States
(12) Patent Application Publication
(10) Pub. No.: US 2011/0119903 A1
(43) Pub. Date: May 26, 2011

(54) CATHODE FOR BATTERY

(75) Inventor: Maya Stevanovic, Danbury, CT (US)

(73) Assignee: The Gillette Company, a Delaware corporation

(21) Appl. No.: 13/018,813

(22) Filed: Feb. 1, 2011

Related U.S. Application Data
(62) Division of application No. 11/313,509, filed on Dec. 21, 2005.

(51) Int. Cl. H01M 6/00; B05D 5/12; B05D 3/12; B29C 43/20

(52) U.S. Cl. 29/623.1; 427/77; 264/134

(57) ABSTRACT

Cathodes that include an active cathode material and a binder are described. The binder includes a first polymeric material and a second material.

### CROSS-REFERENCE TO RELATED APPLICATIONS

This application is a divisional application of and claims priority to U.S. Ser. No. 11/313,509, filed on Dec. 21, 2005, hereby incorporated by reference in its entirety.

### TECHNICAL FIELD

The invention relates to cathodes for batteries.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through a separator between the electrodes to maintain charge balance throughout the battery during discharge.

### SUMMARY

The invention relates to batteries, battery cathodes, and to methods of making the same.

In one aspect, the invention features a cathode that includes a cathode material that includes active material and a binder. The binder includes a blend of a first polymeric material and a second material. In preferred embodiments, the second material is softer than the first polymeric material, e.g., to plasticize the first polymeric material, or otherwise improve the mechanical properties of the first polymeric material, e.g., increase its elongation at break.

In some embodiments, the second material is a second polymeric material and the second polymeric material has a number average molecular weight that is less than a number average molecular weight of the first polymeric material. The second material can be a liquid, e.g., a monomeric liquid, or an oligomer, having a number average molecular weight of less than about 2,000.

The cathode material can be disposed on one or both sides of a current collector. The current collector can be, e.g., in the form of a foil.

In some embodiments, the cathode has a total thickness of less than about 30 mil (0.76 mm), e.g., less than 25 mil (0.64 mm), less than 20 mil (0.51 mm), less than 15 mil (0.38 mm) or even less than 12 mil (0.31 mm). In such embodiments, the cathode generally has a thickness of greater than 8 mil (0.20 mm).

The active material can include, e.g., manganese dioxide. In some embodiments, the cathode material includes between about 85 percent and about 92 percent by weight active material, and between about 0.1 percent and about 5 percent by weight binder.

In another aspect, the invention features a battery including the cathode described herein, and an anode.

In another aspect, the invention features a method of making a cathode that includes a cathode material including an active cathode material and a binder including a blend of a first polymeric material and a second material. The method includes combining a solvent, the active cathode material, the first polymeric material and the second material to provide a slurry; applying the slurry to a first side of a current collector, to provide a coated current collector; and removing the solvent. In some embodiments, the active cathode material is substantially insoluble in the solvent, e.g., having a solubility of less than 0.1 percent by weight.

The method can further include compressing the coated current collector to reduce its thickness, e.g., reducing its thickness such that a thickness after compressing is about 15 percent to about 35 percent less than a thickness prior to compressing. In some embodiments, compressing is accomplished in a nip defined between a pair of co-rotating rolls. The method also can further include applying the slurry to a second side of the current collector, opposite the first side.

In some embodiments, removing the solvent includes evaporating substantially all the solvent, e.g., at nominal atmospheric pressure, and at a temperature of less than about 130° C.

The slurry can be applied to the first side of the current collector, e.g., by passing the current collector through a pair of rotating rolls, at least one of the rolls carrying the slurry. The rolls can be configured, e.g., to separate so as to terminate application of the slurry to the current collector in a predetermined fashion. The slurry can have a viscosity of between about 5,000 and about 25,000 mPas, e.g., between 8,000 and 20,000 mPas or between about 10,000 and 20,000 mPas.

Aspects and/or implementations can have any one or more of the following advantages. The cathode materials can have a high content of active material, e.g., manganese dioxide, allowing cathodes that include the cathode material to have a high loading of the active material. For example, when the cathode includes a current collector having each side coated with the cathode material, each side of the current collector can have, e.g., greater than 50 mg of the cathode material per square centimeter of the current collector. Cathodes that include such a cathode material allow for the construction of batteries that have a relatively high capacity. Such high capacity batteries can be useful, e.g., in medical devices, e.g., heart defibrillators. The cathode materials can have good flexibility, good cohesive strength, and can have a reduced tendency for cracking and delaminating from a substrate, even at low binder levels, e.g., less than 7.5 percent by weight binder. The materials that will make up the binder in the cathode material and the active material are relatively easy to disperse in solvents, e.g., aromatic solvents, and exhibit good adhesive strength to the substrate to which they are applied. The methods used to apply the cathode materials to the substrates often give coatings that are uniform and that have a low number of defects

Other aspects, features, and advantages of the invention are in the drawings, description, and claims.

### DESCRIPTION OF DRAWINGS

FIG. 1 is a top view of a cathode that includes a cathode material disposed on a foil current collector.

FIG. 1A is a cross-sectional view of the cathode of FIG. 1, taken along 1A-1A.

FIG. 2 is a cut-away perspective view of a non-aqueous electrochemical cell that includes the cathode of FIG. 1.

FIGS. 3A and 3B are schematic cross-sectional views of a process for making a foil current collector that carries a cathode material; the figures illustrating coating a first side of a foil current collector with a cathode material (FIG. 3A), and then coating a second side of the foil current collector (FIG. 3B).

FIG. 3C is a schematic cross-sectional view of a process for densifying the coated foil current collector shown in FIG. 3B.

### DETAILED DESCRIPTION

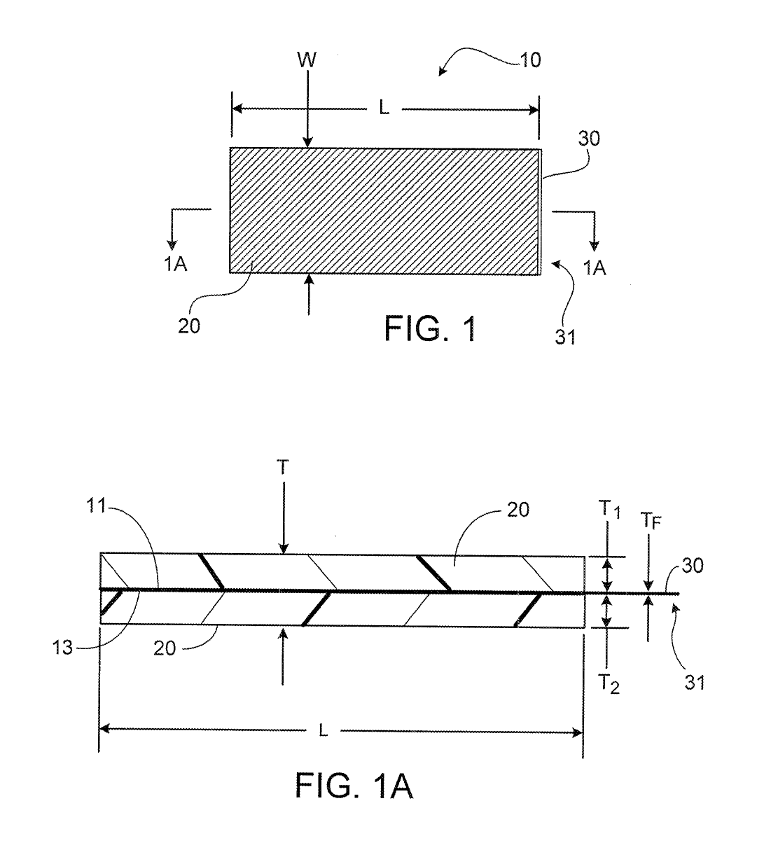

Referring to FIGS. 1 and 1A, a cathode 10 includes a cathode material 20 disposed on a first side 11 and a second side 13 of a foil current collector 30. Cathode 10 has length L, width W and thickness T, which is defined by a thickness T₂ of the cathode material 20 extending from the second side 13 of the current collector 30, a thickness T_{F} of the foil current collector 30, and a thickness T₁ of the cathode material 20 extending from the first side 11 of the current collector 30. Cathode material 20 includes an active material dispersed in a binder. In general, the binder has a good adhesive affinity for the current collector and also has a good adhesive affinity for the materials dispersed therein. The binder includes a blend of a first polymeric material and a second material which can, e.g., plasticize the first polymeric material or otherwise improve the mechanical properties of the first polymeric material (e.g., make it softer or increase its elongation at break). Such cathode materials can have a high content of the active material, and at the same time can have good flexibility, good cohesive strength and can have a reduced tendency for cracking and delaminating from the current collector. Such properties allow for the fabrication of cathodes that are highly loaded with the active material.

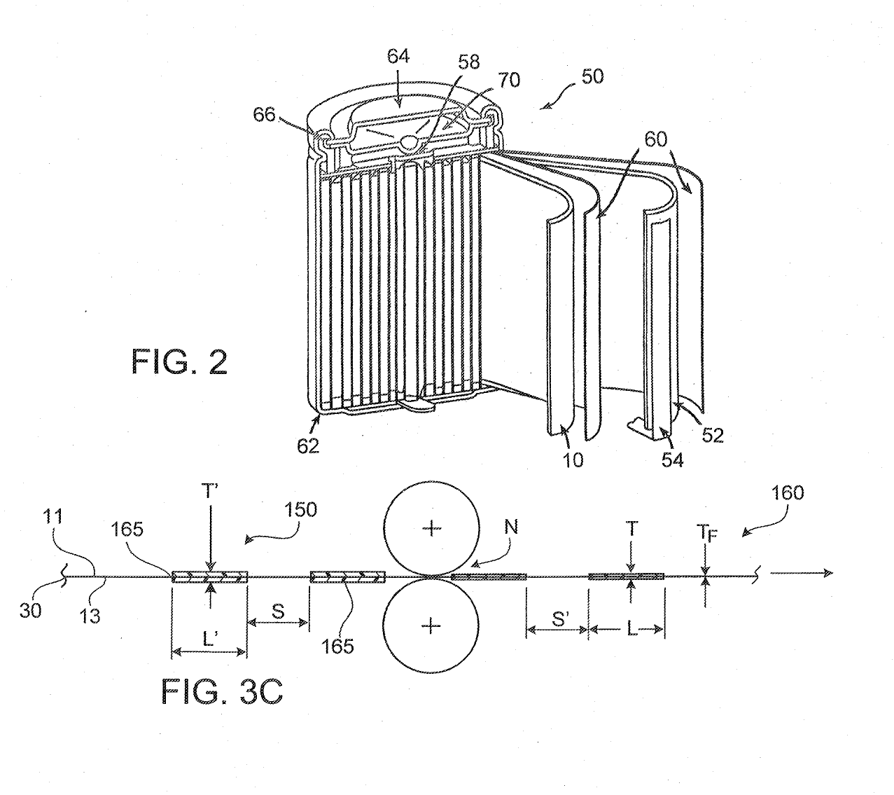

Cathode 10 can be used to fabricate electrochemical cells. Referring as well now to FIG. 2, a primary electrochemical cell 50 includes an anode 52 in electrical contact with a negative lead 54, the cathode 10 from above in electrical contact with a positive lead 58 through tab 31 (FIG. 1), separators 60 and an electrolytic solution. Anode 12, cathode 10, separators 60 and the electrolytic solution are contained within a cylindrical housing 62. The electrolytic solution includes a solvent system and a salt that is at least partially dissolved in the solvent system. Electrochemical cell 50 also includes a cap 64 and an annular insulating gasket 66, as well as a safety valve 70. Positive lead 58 connects cathode 10 to cap 64. Safety valve 70 is configured to reduce the pressure within electrochemical cell 50 when it exceeds a predetermined value.

The first polymeric material can be, e.g., an elastomer, such as an olefinically saturated elastomer, e.g., an olefinically saturated styrenic block copolymer, a polyisobutylene, a hydrogenated polybutadiene, or mixtures of these polymers.

In particular implementations, the first polymeric material includes a styrenic block copolymer, e.g., a styrene-ethylene-butylene-styrene block copolymer having a styrene content of between about 20 percent and about 50 percent by weight, e.g., between about 25 percent and about 45 percent by weight. Such polymers are available under the trade name KRATON®.

The first polymeric material can have, e.g., a number average molecular weight that is between about 35,000 and about 1,000,000, e.g., between about 75,000 and about 750,000, or between about 150,000 and 500,000, as determined by gel permeation chromatography (GPC) using a universal calibration curve.

The first polymeric material can have a hardness, e.g., of less than 95 Shore A, e.g., less than 90 Shore A, less than 85 Shore A, or less than 80 Shore A, as measured at room temperature using ASTM D2240 on plaques compression molded at 300° C.

The first polymeric material can have, e.g., an elongation at break of greater than about 300 percent, e.g., greater than 400 percent, greater than 500 percent, or greater than 750 percent, as measured at room temperature using ASTM D412.

The second material can be, e.g., a monomeric material such as a hydrocarbon oil, an oligomeric material, e.g., having a number average molecular weight of less than 2,000 (as determined using a universal calibration curve), or a polymeric material having a number average molecular weight of greater than 2,000 (as determined using a universal calibration curve).

At room temperature, the second material can be a solid or a liquid.

In instances in which the second material is a monomeric material, the second material can be, e.g., oil (e.g., a mineral oil, a white oil, a petrolatum, a silicone oil, or mixtures of these oils). Mineral oils, white oils and petrolatums are available from Crompton.

In instances in which the second material is an oligomeric material, the material can be, e.g., an oligomeric polyethylene wax, an oligomeric hydrogenated polybutadiene, an oligomeric polyisobutylene, or mixtures of these oligomers.

In instances in which the second material is a higher molecular weight polymeric material, the polymeric material can be, e.g., an elastomer, such as an olefinically saturated elastomer (e.g., an olefinically saturated styrenic block copolymer, a polyisobutylene, a hydrogenated polybutadiene, or mixtures of these polymers).

In particular implementations, the second material includes a polymeric material that includes a styrenic block copolymer, e.g., a styrene-ethylene-butylene-styrene block copolymer having a styrene content of less than about 25 percent, e.g., less than 20 percent, less than 15 percent, less than 12.5 percent, less than 10 percent, or less than 7.5 percent.

In particular implementations, the second material includes a polymeric material that has a number average molecular weight of less than 45,000, e.g., less than 30,000, less than 25,000, less than 20,000, less than 10,000 or less than 5,000, as determined using a universal calibration curve.

In particular implementations, the second material is a polymeric material. In such instances, the first polymeric material has a first number average molecular weight and the second polymeric material has a second number average molecular weight that is less than the first number average molecular weight, as determined using a universal calibration curve. For example, the second number average molecular weight can be less that seventy-five percent of the first number average molecular weight, e.g., less than fifty percent, or even less than twenty-five percent.

In particular implementations, the second material includes a polymeric material having hardness of, e.g., of less than 65 Shore A, e.g., less than 60 Shore A, less than 55 Shore A, or less than 40 Shore A, as measured at room temperature using ASTM D2240 on plaques compression molded at 300° C.

In some implementations, the second material is a polymeric material having a hardness less than the hardness of the first polymeric material. Such implementations can provide particularly soft, resilient and plasticized cathode materials.

In particular implementations, the second material includes a polymeric material that has an elongation at break of, e.g., greater than about 300 percent, e.g., greater than 400 percent, greater than 500 percent, greater than 750 percent, or even greater than 1000 percent, as measured at room temperature using ASTM D412.

In some implementations, the cathode material includes less than 7.5 percent by weight binder, e.g., less than 5 percent, less than 4 percent, less than 3 percent, less than 2.5 percent, or even less than 2 percent.

The cathode material includes at least one active material, e.g., two, three, four or five different active materials. The active material can be, e.g., a metal oxide, such as a manganese oxide or a metal sulfide, such as FeS₂. In some implementations, the active material is manganese dioxide (MnO₂), such as EMD, CMD, gamma-MnO₂, or a combination (e.g., a blend) of any of these materials. Distributors of manganese dioxides include Kerr-McGee Corp. (manufacturer of, e.g., Trona D and high-power EMD), Tosoh Corp., Delta Manganese, Delta EMD Ltd., Mitsui Chemicals, ERACHEM, and JMC. Gamma-MnO₂ is described, e.g., in “Structural Relationships Between the Manganese (IV) Oxides”, Manganese Dioxide Symposium, 1, The Electrochemical Society, Cleveland, 1975, pp. 306-327, which is incorporated herein by reference in its entirety. In certain embodiments, the active material can be another type of manganese oxide composition. For example, the cathode active material can be HEMD, or can be a lithium manganese oxide composition, such as lithiated MnO₂, or LiMD. In some implementations, the cathode active material can be a lithium manganese oxide composition that is formed by the lithiation of MnO₂ and subsequent heat treatment of the lithiated MnO₂ in an oxygen atmosphere. In certain implementations, the cathode active material can be MnO₂ that includes from about 0.1 percent to about two percent lithium by weight. Manganese oxide compositions are described, e.g., in Bofinger et al., U.S. Patent Application Publication No. US 2005/0164085 A1, published on Jul. 28, 2005, and in Bofinger et al, U.S. Patent Application Publication No. US 2005/0164086 A1, published on Jul. 28, 2005, both of which are incorporated herein by reference herein in their entirety.

The active material can have a particle size, e.g., of between about 5 microns and about 100 microns. In some implementations, the active material has a particle size of less than about 20 microns, e.g., less than 15 microns, less than 10 microns, less than 8 microns, less than 5 microns, less than 1 micron, or even less than 0.5 micron.

The cathode material includes, e.g., between about 85 percent and about 95 percent by weight active material, e.g., between about 85 percent and about 92 percent or between about 87.5 percent and 92 percent by weight active material.

The foil current collector can be made of aluminum or an aluminum alloy, e.g., 1N30 aluminum alloy having a temper of H18. It can also be made of other material that are relatively strong and good electrical conductors.

The cathode material can also include charge control agents, e.g., a carbon source (e.g., carbon black, synthetic graphite, natural graphite, acetylenic mesophase carbon, coke, carbon nanofibers, or mixtures of these materials).

When present, the charge control agents can have a particle size of less than about 20 microns, e.g., less than 15 microns, less than 10 microns, less than 8 microns, less than 5 microns, less than 1 micron, or even less than 0.5 micron. In some implementations, the charge control agents have a particle size of, e.g., between about 5 microns and about 100 microns.

The cathode material can include, e.g., less than 7.5 percent by charge control agents, e.g., less than 5 percent, less than 4 percent, less than 3 percent, less than 2.5 percent, or less than 2 percent.

The cathode material can have a porosity, e.g., of between about 15 percent and about 40 percent, e.g., between 20 percent and 40 percent, e.g. between about 25 percent and about 35 percent.

In some implementations, greater than 60 mg of the cathode material per side is disposed on the current collector per square centimeter of the current collector, e.g., greater than 65, greater than 70, greater than 75, greater than 80 or even greater than 85 mg per square centimeter of the current collector.

The length L of the cathode can be, e.g., from about 0.25 inch (0.64 cm) to about 3 inches (7.62 cm), e.g., from about 0.5 inch (1.27 cm) to about 2.5 inches (6.35 cm), or from about 0.75 inch (1.91 cm) to about 2 inches (5.08 cm); and the width W of the cathode can be, e.g., from about 0.25 inch (0.64 cm) to about 3 inches (7.62 cm), e.g., from about 0.5 inch (1.27 cm) to about 2.5 inches (6.35 cm), or from about 0.75 inch (1.91 cm) to about 2 inches (5.08 cm).

In some implementations, the cathode has a total thickness T of less than about 50 mil (1.27 mm), e.g., less than about 40 mil (1.08 mm), or less than about 30 mil (0.76 mm); the cathode material has a thickness T₁ and T₂ of less than 25 mil (0.64 mm), e.g., less than 20 mil (0.51 mm), less than 15 mil (0.38 mm), less than 12.5 mil (0.32 mm), or less than 10 mil (0.25 mm); and the foil has a thickness of less than about 50 microns, e.g., less than 35 microns, less than 25 microns, less than 20 microns or less than 15 microns.

Generally, cathode 10 is made by combining a solvent, with the active cathode material, the first polymeric material and the second material to provide a slurry, and then applying the slurry to current collector, to provide a coated current collector. The solvent is removed, e.g., by evaporation, from the coated current collector, and then coated current collector cut to a desired size/shape to provide the desired cathode. Addition of the second material can, e.g., plasticize the first material, making cathode materials more uniform and with fewer defects.

In particular implementations, cathode 10 is prepared by coating a first side of a current collector; drying the coated current collector; and then repeating the process on the second side of the current collector. The current collector is then densified and cut to a desired size/shape to provide the desired cathode.

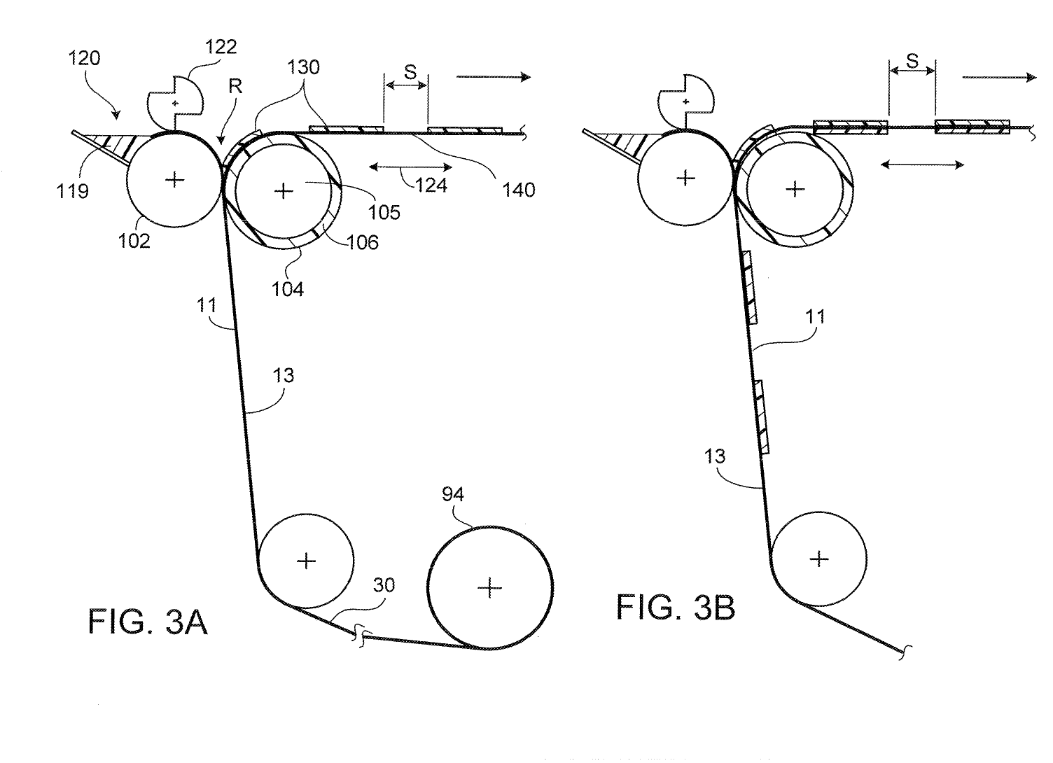

Referring now to FIGS. 3A and 3B, a continuous web of the foil current collector 30 from a spool 94 is introduced to a region R defined between counter-rotating rolls 102,104. Roll 102 is formed from of a metal, e.g. stainless steel. Roll 104 includes an inner portion 105 formed of a metal and a outer portion 106 surrounding the inner portion that is made of a high friction, resilient material that is chemically inert, such as a highly crosslinked rubber. Outer portion 106 provides adequate traction to pull the web through the region R. Slurry 119 that includes the solvent, the active cathode material and the binder is applied to roll 102 from reservoir 120. Knife edge roller 122 ensures consistent coating thickness applied to roll 102. Roll 102 transfers the slurry 119 to the continuous web, forming patches of slurry 130 extending from the first side 11 of the foil current collector 30. Rolls 102 and 104 are configured to separate, as indicated by double arrow 124, so as to terminate application of the slurry to the current collector in a predetermined fashion. Such a process can be cam or computer controlled and produces mass free zones 140 defining spacing S between immediately adjacent patches 130. The continuous web having the patches 130 is then dried and then collected on a spool (not shown) After solvent removal, the coating process is repeated on the second side of the current collector 13 (FIG. 3B), to produce a continuous web of foil material having both sides coated.

The continuous web can move through region R at a rate of between about 0.1 meters/minute to 3 meters/minute, e.g., between about 0.2 meters/minute to about 0.15 meters/minute.

In some implementations, the removal of the solvent occurs at a temperature of less than about 130° C., e.g. less than 110° C., less than 100° C. or less than 90° C. In some implementations, the solvent is evaporated at nominal atmospheric pressure.

The active cathode material can be, e.g., substantially insoluble in the solvent, e.g., less than 0.1 percent by weight is soluble. The solvent can be, e.g., an aromatic hydrocarbon, an aliphatic hydrocarbon or mixtures of these solvents. Such solvents are available from Shell Chemical under the trade name SHELLSOL™, e.g., SHELLSOL™ OMS or SHELLSOL™ A100.

The first polymeric material and the second material combined can make up, e.g., from about 1 percent to about 5 percent by weight of a total slurry weight, e.g., from about 1 percent to about 3 percent. In some implementations, the first polymeric material and the second material combined make up less than about 3 percent by weight binder, e.g., less than 2 percent or even less than 1 percent by weight.

A weight ratio of the first polymeric material to the second material is, e.g., from about 5:1 to about 1:1, e.g., from about 3:1 to about 1:1.

In some implementations, the slurry includes from about 60 percent to about 80 percent by weight active material, e.g., from about 65 percent to about 75 percent by weight active material.

The slurry can include, e.g., from about 2 percent to about 6 percent by weight charge control agents, e.g., from about 2 percent to about 4 percent by weight charge control agents.

In some implementations, the slurry has a viscosity of between about 5,000 and about 25,000 mPas, e.g., between about 10,000 and about 20,000 mPas.

Referring to now to FIG. 3B, the continuous web of foil material with the solvent removed which carries the cathode material on both sides (produced from the process shown in FIG. 3B), is densified by passing the web 150 through counter-rotating pressure rolls 160,162 that define a nip N. The web carrying the densified cathode material 160 is then cut to a desired size/shape to provide the cathode 10.

Before densification, patches 165 have overall thickness T′, and length U. The spacing between patches 165 is S. After densification, the thickness is reduced to T, the length is increased to L and the spacing between patches is reduced to S′.

In some implementations, after densification, thickness T is from about 15 percent to about 45 percent less than thickness T′, e.g., from about 15 percent to about 40 percent less, or from about 15 percent to about 35 percent less.

Further embodiments are in the following examples.

### Examples

### Materials

Manganese dioxide (electrolytic grade, β-structure) was obtained from Kerr-McGee Corporation; carbon black (Soltex AB55) was obtained from Chevron and graphite (Timrex KS6) was obtained from Timcal Corporation, each of which was used without as received. Solvents, SHELLSOL™ A100 and SHELLSOL™ OMS, were obtained from Shell Chemical, and were used as received. SHELLSOL™ A100 is a mixture of predominantly C₉ is aromatic hydrocarbons and SHELLSOL™ OMS is a low odor isoparaffinic solvent. KRATON™ G1651 and G1657 were obtained from Kraton Polymers Holdings B.V. as powders, and were used as received. KRATON™ G1651 and G1657 are both styrenic block copolymers having ethylene/butylene soft segments. OPPANOL® 10 B was obtained from BASF Performance Chemicals, and was used as received. OPPANOL® 10 B is a polyisobutene-based polymer, and was used as received. REGALREZ™ 1085 was obtained from Eastman, and was used as received. REGALREZ™ 1085 hydrocarbon resin is saturated hydrocarbon resin having a relatively low molecular weight.

### Slurry Formulation

The following slurry formulations were combined and mixed with a double shaft, planetary/impeller mixer for 40 minutes under cooling.

Slurry Formulation A

| COMPONENT | WEIGHT |
|---|---|
| KRATON ™ G1651 | 6.7 g |
| KRATON ™ G1657 | 6.7 g |
| MnO₂ | 63.1 g |
| Carbon black | 26.8 g |
| Graphite | 13.4 g |
| SHELLSOL ™ A100 | 86.4 g |
| SHELLSOL ™ OMS | 129.6 g |

Slurry formulation B

| COMPONENT | WEIGHT |
|---|---|
| KRATON ™ G1651 | 9.4 g |
| OPPANOL ® 10 B | 4.0 g |
| MnO₂ | 63.1 g |
| Carbon black | 26.8 g |
| Graphite | 13.4 g |
| SHELLSOL ™ A100 | 86.4 g |
| SHELLSOL ™ OMS | 129.6 g |

Slurry formulation C

| | |
|---|---|
| KRATON ™ G1651 | 9.4 g |
| REGALREZ ™ 1085 | 4.0 g |
| MnO₂ | 63.1 g |
| Carbon black | 26.8 g |
| Graphite | 13.4 g |
| SHELLSOL ™ A100 | 86.4 g |
| SHELLSOL ™ OMS | 129.6 g |

All formulations were coated onto a current collector using roll coating methods and then cut into cathodes. Prismatic batteries were fabricated from the cathodes. The finished cathodes had the following properties.

| | Formula | | |
|---|---|---|---|
| | Formula A | Formula B | Formula C |
| Loading | 162 | 156 | 130 |
| (mg/cm²) | | | |
| Thickness (mm) | 0.610 | 0.584 | 0.508 |
| Porosity (percent) | 34 | 33 | 35 |

A number of embodiments of the disclosure have been described. Nevertheless, it will be understood that various modifications may be made without departing from the spirit and scope of the disclosure.

While current collectors in the form of thin foils have be shown, other shapes can be used. For example, current collectors can be in the shape of sheet, e.g., that is 0.025 inch thick, can be used.

While current collectors made of aluminum and aluminum alloy have been described, the current collector can be fabricated from other materials, e.g., copper, silver or gold.

While cylindrical electrochemical cells have been shown, other shapes can be used.

While roll coating methods have been shown, other methods, e.g., solution extrusion, can be employed to coat current collectors.

Still other embodiments are within the scope of the following claims.

1-21. (canceled)

22. A method of making a cathode comprising:
mixing a solvent, an uncoated active cathode material, a first polymeric material, and a second material different from the first polymeric material to provide a slurry;
applying the slurry to a first side of a current collector, to provide a coated current collector; and
removing the solvent to provide the cathode having a cathode material comprising the cathode active material, the first polymeric material, and the second material,
wherein
the first polymeric material is selected from the group consisting of:
an elastomer selected from the group consisting of an olefinically saturated elastomer, an olefinically saturated styrenic block copolymer, a polyisobutylene, a hydrogenated polybutadiene, mixtures thereof,
a polymer selected from the group consisting of a styrene block copolymer, a styrene-ethylene-butylene-styrene block copolymer, and
mixtures thereof, and
the second material is selected from the group consisting of:
a hydrocarbon oil selected from the group consisting of a mineral oil, a white oil, a petrolatum, a silicone oil, and mixtures thereof,
an oligomeric material selected from the group consisting of an oligomeric polyethylene wax, an oligomeric hydrogenated polybutadiene, an oligomeric polyisobutylene, and mixtures thereof,
a second polymeric material selected from the group consisting of a styrenic block copolymer, a styrene-ethylene-butylene-styrene block copolymer, and an elastomer, wherein the elastomer is selected from the group consisting of an olefinically saturated styrenic block copolymer, a polyisobutylene, and a hydrogenated polybutadiene.

23. The method of claim 22, further comprising compressing the coated current collector to reduce its thickness.

24. The method of claim 23, wherein the compressing is accomplished in a nip defined between a pair of rotating rolls.

25. The method of claim 22, further comprising applying the slurry to a second side of the current collector, opposite the first side.

26. The method of claim 22, wherein the applying of the slurry to the first side of the current collector is performed by passing the current collector through a pair of rotating rolls, at least one of the rolls carrying the slurry.

27. The method of claim 26, wherein the rolls are configured to separate so as to terminate application of the slurry to the current collector in a predetermined fashion.

28. The method of claim 22, wherein the slurry has a viscosity of between about 5,000 and about 25,000 mPas.

29. The method of claim 25, further comprising compressing the coated current collector to reduce its thickness.

30. The method of claim 29, wherein the compressing is accomplished in a nip defined between a pair of rotating rolls.

31. The method of claim 22, further comprising mixing a carbon source with the solvent, the uncoated active cathode material, the first polymeric material, and the second material different from the first polymeric material to provide the slurry.

32. The method of claim 22, wherein the cathode active material is selected from the group consisting of manganese dioxide and iron disulfide.

33. The method of claim 22, wherein the cathode active material is iron disulfide.

34. The method of claim 22, wherein the first polymeric material has a first number average molecular weight and the second polymeric material has a second number average molecular weight that is less than the first number average molecular weight.

35. The method of claim 22, wherein the first and second polymeric materials are each an elastomer.

36. The method of claim 22, wherein the first polymeric material is a styrenic block copolymer.

37. The method of claim 36, wherein the styrenic block copolymer is a styrene-ethylene-butylene-styrene block copolymer.

38. The method of claim 37, wherein a styrene content of the styrene-ethylene-butylene-styrene block copolymer is between about 20 percent and about 50 percent by weight.

39. The method of claim 22, wherein the second material is a second polymeric material selected from the group consisting of an olefinically saturated styrenic block copolymer, a polyisobutylene, a hydrogenated polybutadiene, a styrenic block copolymer, a styrene-ethylene-butylene-styrene block copolymer, and mixtures thereof.

40. The method of claim 39, wherein the second polymeric material is selected from the group consisting of styrenic block copolymers, polyisobutylenes, hydrogenated polybutadienes, and mixtures thereof.

41. The method of claim 39, wherein the second polymeric material is a styrene-ethylene-butylene-styrene block copolymer.

42. The method of claim 41, wherein a styrene content of the styrene-ethylene-butylene-styrene block copolymer is less than about 20 percent by weight.

43. The method of claim 22, wherein greater than 60 mg of the cathode material is disposed on the first side of the current collector per square centimeter of the current collector.

44. The method of claim 22, wherein the cathode has a total thickness of less than about 30 mil.

45. A method of making a battery, comprising:
incorporating into a battery a cathode, the cathode having been prepared by mixing a solvent, an uncoated cathode active material, a first polymeric material, and a second material different from the first polymeric material to provide a slurry;
applying the slurry to a first side of a current collector to provide a coated current collector; and
removing the solvent to provide the cathode having a cathode material comprising the cathode active material, the first polymeric material, and the second material,
wherein
the first polymeric material is selected from the group consisting of:
an elastomer selected from the group consisting of an olefinically saturated elastomer, an olefinically saturated styrenic block copolymer, a polyisobutylene, a hydrogenated polybutadiene, mixtures thereof,
a polymer selected from the group consisting of a styrene block copolymer, a styrene-ethylene-butylene-styrene block copolymer, and
mixtures thereof, and
the second material is selected from the group consisting of:
a hydrocarbon oil selected from the group consisting of a mineral oil, a white oil, a petrolatum, a silicone oil, and mixtures thereof,
an oligomeric material selected from the group consisting of an oligomeric polyethylene wax, an oligomeric hydrogenated polybutadiene, an oligomeric polyisobutylene, and mixtures thereof,
a second polymeric material selected from the group consisting of a styrenic block copolymer, a styrene-ethylene-butylene-styrene block copolymer, and an elastomer, wherein the elastomer is selected from the group consisting of an olefinically saturated styrenic block copolymer, a polyisobutylene, and a hydrogenated polybutadiene.

46. The method of claim 45, wherein the cathode active material is selected from the group consisting of manganese dioxide and iron disulfide.

47. The method of claim 45, wherein the cathode active material is iron disulfide.
